(19) United States
(12) Patent Application Publication
(10) Pub. No.: US 2008/0074601 A1
(43) Pub. Date: Mar. 27, 2008

(54) LIQUID CRYSTAL DISPLAY

(75) Inventors: Back-Won LEE, Cheonan-si (KR); Sahng-Ik JUN, Yongin-si (KR); Yoon-Jang KIM, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/861,647

(22) Filed: Sep. 26, 2007

(30) Foreign Application Priority Data
Sep. 26, 2006 (KR) 10-2006-0093305

(51) Int. Cl. G02F 1/1343

(52) U.S. Cl. 349/144

(57) ABSTRACT

A liquid crystal display including a plurality of pixels arranged in a matrix and including first and second pixels, first and second gate lines opposing each other, and first and second data lines intersecting the gate lines. Each of the first and second pixels includes a plurality of pixel electrodes each of which includes first and second sub-pixel electrodes, a first switching element disposed on the right side of the first data line, and a second switching element disposed on the left side of the second data line. The first switching element is connected to the first sub-pixel electrode while the second switching element is connected to the second sub-pixel electrode in the first pixel, and the first switching element is connected to the second sub-pixel electrode while the second switching element is connected to the first sub-pixel electrode in the second pixel.

This application claims priority to Korean Patent Application No. 10-2006-0093305, filed on Sep. 26, 2006, and all the benefits accruing therefrom under 35 U.S.C. §119, the contents of which in its entirety are herein incorporated by reference.

### BACKGROUND OF THE INVENTION

(a) Field of the Invention

The present invention relates to a liquid crystal display.

(b) Description of the Related Art

Liquid crystal displays “LCDs” are currently one of the most commonly used flat panel displays, wherein an LCD includes a pair of panels provided with field-generating electrodes such as pixel electrodes and a common electrode and a liquid crystal (LC) layer interposed between the two panels. The LCD displays images by applying voltages to the field-generating electrodes to generate an electric field in the LC layer that determines the orientations of LC molecules therein to adjust polarization of incident light.

An LCD also includes switching elements connected to the respective pixel electrodes, and a plurality of signal lines such as gate lines and data lines for controlling the switching elements, and thereby applying voltages to the pixel electrodes.

Various methods for improving the motion picture display characteristics of LCDs have been attempted, including the development of high-speed driving techniques. Because high-speed driving methods consume relatively large amounts of power in LCD devices due to a high frame speed, column inversion driving methods have been employed to minimize the power consumption.

However, in the case of a column inversion drive, when a box that has a higher gray than the background screen having a lower gray is displayed in the center of a screen, a vertical crosstalk phenomenon may occur, in which the gray above and below the box is different from that of the background screen. Also, vertical flickering may be caused when data voltages of the same polarity are applied vertically and there is a difference between data voltages of positive polarity and negative polarity.

It would therefore be desirable to be able to provide an LCD that does not suffer degradation of image quality when implementing a high-speed, column inversion driving method.

### BRIEF SUMMARY OF THE INVENTION

Aspects of the present invention provide a liquid crystal display showing no degradation of image quality in a high-speed column inversion driving method. Additional aspects of the invention provide a liquid crystal display in which drain electrodes are in a floating state during a process such that occurrence of static electricity inferiority is prevented.

According to an exemplary embodiment of the present invention, a liquid crystal display includes a plurality of pixels arranged in a matrix and grouped into one of first and second pixels, a plurality of gate lines including a plurality of pairs of first and second gate lines opposing each other with respect to the plurality of pixels; and a plurality of data lines including a plurality of pairs of first and second data lines intersecting the gate lines. Each of the first and second pixels further includes a plurality of pixel electrodes, each of the pixel electrodes including first and second sub-pixel electrodes; a first switching element disposed on the right side of the first data line, a second switching element disposed on the left side of the second data line, wherein the first switching element is connected to the first sub-pixel electrode while the second switching element is connected to the second sub-pixel electrode in the first pixel, and the first switching element is connected to the second sub-pixel electrode while the second switching element is connected to the first sub-pixel electrode in the second pixel.

In one aspect, the total number of data lines may be twice the total number of columns of the pixels, and the total number of gate lines may be one more than the total number of rows of the pixels.

Data voltages applied to the first and second sub-pixel electrodes may be different from each other and obtained from single image information.

The first pixels and the second pixels may be alternately disposed in a row direction.

The first pixels and the second pixels may be alternately disposed in a column direction.

Polarities of data voltages applied to neighboring data lines may be opposite to each other.

The polarity of a voltage of the first sub-pixel electrode may be opposite to the polarity of a voltage of the second sub-pixel electrode.

Polarities of voltages of the first sub-pixel electrodes neighboring each other in a row and a column direction may be opposite to each other.

Polarities of voltages of the second sub-pixel electrodes neighboring each other in a row and a column direction may be opposite to each other.

The area of the first sub-pixel electrode may be smaller than the area of the second sub-pixel electrode.

The voltage of the first sub-pixel electrode may be higher than the voltage of the second sub-pixel electrode.

A first cutout may be formed in at least one of the first and second sub-pixel electrodes.

The liquid crystal display may further include a common electrode opposing the pixel electrode, wherein a second cutout may be formed in the common electrode.

The first gate line may be connected with the last gate line.

The liquid crystal display may further include a storage electrode overlapping the first and second sub-pixel electrodes, wherein the first switching element includes a first gate electrode, a first source electrode, and a first drain electrode, and the second switching element comprises a second gate electrode, a second source electrode, and a second drain electrode. The first drain electrode and the second drain electrode include first and second expansions overlapping the storage electrode, respectively, and the first drain electrode is physically connected to the first expansion while the second drain electrode is physically connected to the second expansion.

In another aspect, each pixel electrode may have a substantially quadrangle shape.

The first and second sub-pixel electrodes may be disposed relative to each other with a gap interposed therebetween, with the first sub-pixel electrode being interposed in the center of the second sub-pixel electrode.

The liquid crystal display may further include a center cutout, a pair of upper cutouts, and a pair of lower cutouts formed in the second sub-pixel electrode, the second sub-pixel electrode thereby being divided into a plurality of regions by the cutouts; and a storage electrode overlapping the first and second sub-pixel electrodes, wherein the cutouts have a substantially inverted symmetry with respect to the storage electrode.

The pairs of lower and upper cutouts may extend in a substantially oblique manner from a right edge of the pixel electrode to the left and to one of an upper edge and a lower edge of the pixel electrode.

The pairs of lower and upper cutouts may extend substantially perpendicular to each other.

The center cutout may be generally Y-shaped, having a central transverse portion and a pair of oblique portions, with the central transverse portion extending approximately along the storage electrode, and the pair of oblique portions extending approximately parallel with the pairs of lower and upper cutouts, respectively.

The liquid crystal display may further include a common electrode opposing the pixel electrode, the common electrode further comprising a set of cutouts, including first and second center cutouts, a plurality of upper cutouts, and plurality of lower cutouts.

Each of the plurality of lower and upper cutouts may include an oblique branch, a transverse branch, and a longitudinal branch, the oblique branch extending approximately from a right edge of the pixel electrode to the left and to one of the upper edge and the lower edge of the pixel electrode, the transverse branch and the longitudinal branch extending from respective ends of the oblique branch along the edges of the pixel electrode, overlapping the edges of the pixel electrode and forming obtuse angles with the oblique branch.

Each of the first and second center cutouts may include a central transverse branch, a pair of oblique branches, and a pair of terminal longitudinal branches, the central transverse branch extends approximately from a right edge of the pixel electrode to the left along a transverse center line, and the pair of oblique branches extending from an end of the central transverse branch toward the left edge of the pixel electrode, and the terminal longitudinal branches extending from the respective ends of the oblique branches along the left edge of the pixel electrode, overlapping the left edge of the pixel electrode and forming obtuse angles with the oblique branches.

Each of the oblique branches of the lower and upper cutouts may include notches formed therein, and each of the oblique branches of the first and second center cutouts may include notches formed therein.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of an LCD according to an exemplary embodiment of the present invention;

FIG. 2 is an equivalent circuit diagram of two sub-pixels of an LCD according to an exemplary embodiment of the present invention;

FIG. 3 is an equivalent circuit diagram of a pixel of an LCD according to an exemplary embodiment of the present invention;

FIG. 4 is a schematic diagram illustrating pixel disposition, signal line disposition, and pixel polarities of an LCD according to an exemplary embodiment of the present invention;

FIG. 5 is a layout view of a lower panel for a pixel of an LC panel assembly according to an exemplary embodiment of the present invention;

FIG. 6 is a layout view of an upper panel for a pixel of an LC panel assembly according to an exemplary embodiment of the present invention;

FIG. 7 is a layout view of an LC panel assembly including the lower panel shown in FIG. 5 and the upper panel shown in FIG. 6;

FIG. 8 and FIG. 9 are cross-sectional views of the LC panel assembly shown in FIG. 7 taken along the line VIII-VIII and the line IX-IX, respectively; and

FIG. 10 is a layout view illustrating another pixel of an LC panel assembly according to another exemplary embodiment of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Exemplary embodiments of the present invention will hereinafter be described in detail with reference to the accompanying drawings.

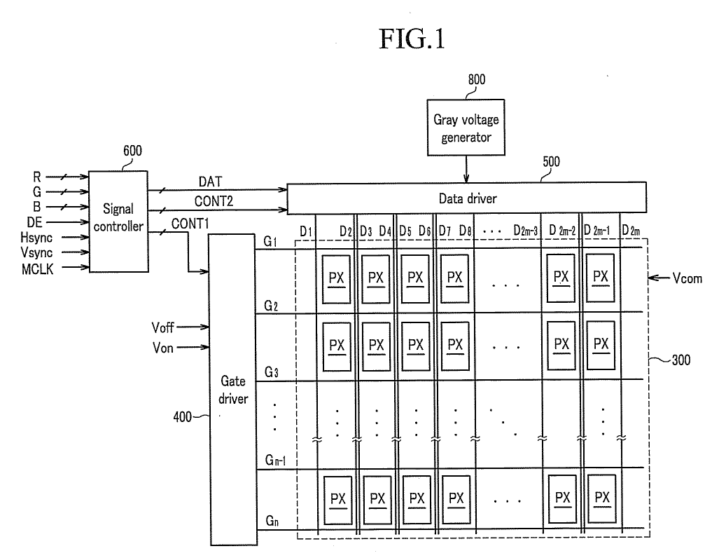

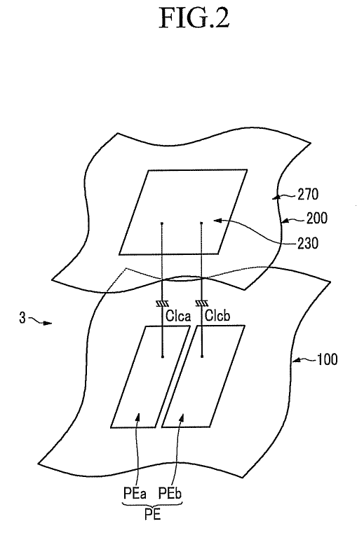

FIG. 1 is a schematic block diagram of an LCD according to an exemplary embodiment of the present invention, and FIG. 2 is an equivalent circuit diagram of two sub-pixels of an LCD according to an exemplary embodiment of the present invention.

As shown in FIG. 1, an LCD according to an exemplary embodiment of the present invention includes a liquid crystal “LC” panel assembly 300, a gate driver 400 and a data driver 500 that are connected to the LC panel assembly 300, a gray voltage generator 800 connected to the data driver 500, and a signal controller 600 for controlling the above elements.

The LC panel assembly 300 includes a plurality of signal lines G₁-Gₙ and D₁-D₂ₘ, and a plurality of pixels PX connected to the signal lines and arranged substantially in a matrix, as seen in the equivalent circuit diagram. In addition, the LC panel assembly 300 includes lower and upper panels 100 and 200 that face each other with an LC layer 3 interposed therebetween, as particularly shown in FIG. 2.

As indicated above, the signal lines include a plurality of gate lines G₁-Gₙ for transmitting gate signals (also referred to as “scanning signals”) and a plurality of data lines D₁-D₂ₘ for transmitting data signals. The gate lines G₁-Gₙ extend substantially in a row direction and are substantially parallel to each other, and the data lines D₁-D₂ₘ extend substantially in a column direction and are substantially parallel to each other. A given pair of the data lines D₁-D₂ₘ is disposed at each side of a pixel PX.

As particularly shown in FIG. 2, each pixel PX includes a pair of sub-pixels PEa and PEb. Each sub-pixel PEa and PEb in turn includes a switching element (not shown in FIG. 2) connected to the signal lines GL and DL, LC capacitors Clca and Clcb, and a storage capacitor (not shown in FIG. 2) that are connected to the switching element. The storage capacitor may optionally be omitted as necessary.

The switching element includes a three-terminal, thin film transistor “TFT” provided on the lower panel 100, wherein the control terminal thereof is connected to the gate line GL, the input terminal thereof is connected to the data line DL, and the output terminal thereof is connected to LC capacitors Clca and Clcb and the storage capacitor.

The storage capacitor functions as an auxiliary capacitor for the LC capacitors Clca and Clcb, and is formed by overlapping another signal line (not shown in FIG. 2) provided on the lower panel 100 with a pixel electrode PEa and PEb via an insulator disposed therebetween. This signal line is supplied with a predetermined voltage, such as a common voltage Vcom. Alternatively, the storage capacitor may be formed by overlapping a pixel electrode PE with the previous gate line thereabove via an insulator.

In order to implement color display, each pixel PX uniquely displays one of a set of primary colors (spatial division) or, alternatively, each pixel PX sequentially displays the primary colors in turn (temporal division) such that the spatial or temporal sum of the primary colors is recognized as a desired color. An example of a set of the primary colors includes red, green, and blue. FIG. 2 illustrates an example of the spatial division in which each pixel PX includes a color filter 230 representing one of the primary colors in an area of the upper panel 200 facing a pixel electrode PE. In lieu of the arrangement illustrated in FIG. 2, the color filter 230 may alternatively be provided on or under a pixel electrode PE provided on the lower panel 100.

Polarizers (not shown in FIG. 2) are provided on the outer surface of the panels 100 and 200, wherein the polarization axes of two polarizers may be perpendicular to each other. One of the two polarizers may be omitted when the LCD is a reflective LCD. In the case of perpendicular polarizers, incident light flowing into the LC layer 3 in the absence of an electric field is unable to pass through the polarizer.

Referring once again to FIG. 1, the gray voltage generator 800 generates two sets of a plurality of gray voltages (or reference gray voltages) related to the transmittance of the pixels PX. Gray voltages of one set have a positive value with respect to the common voltage Vcom, while gray voltages of the other set have a negative value with respect to the common voltage Vcom.

The gate driver 400 is connected to the gate lines of the LC panel assembly 300, and utilized a gate-on voltage input signal (Von) and a gate-off voltage input signal (Voff) to generate output gate signals Vg, which are applied to the gate lines.

The data driver 500 is connected to the data lines D₁-D₂ₘ of the LC panel assembly 300, and selects the gray voltages supplied from the gray voltage generator 800 and then applies the selected gray voltage to the data lines D₁-D₂ₘ as data signals. However, in the event that the gray voltage generator 800 supplies only reference gray voltages of a predetermined number rather than supplying voltages for all grays, the data driver 500 divides the reference gray voltages to generate gray voltages for all grays, from which data signals are selected.

The signal controller 600 controls both the gate driver 400 and the data driver 500.

Each of the drivers 400, 500, 600, and 800 mentioned above may be directly mounted on the LC panel assembly 300 in the form of at least one integrated circuit (IC) chip, or one or more of the same may be mounted on a flexible printed circuit film (not shown) as a tape carrier package (TCP) type that is attached to the LC panel assembly 300, or they may be mounted on a separate printed circuit board (not shown). Alternatively, each of the drivers 400, 500, 600, and 800 may be integrated into the LC panel assembly 300. Further, the drivers 400,500, 600, and 800 may be integrated into a single chip, in which case, at least one thereof or at least one circuit element forming the same may be located outside of the single chip.

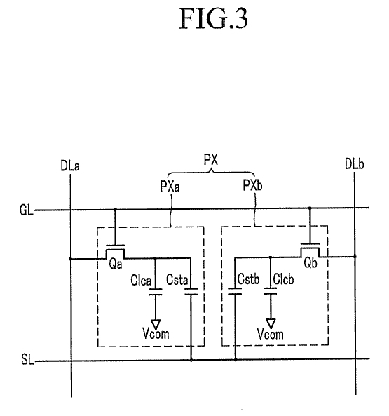

An exemplary structure of the LC panel assembly will now be described in detail with reference to FIG. 3 to FIG. 9, along with FIG. 1 and FIG. 2 described above.

FIG. 3 is an equivalent circuit diagram of a pixel of an LC panel assembly according to an exemplary embodiment of the present invention.

Referring to FIG. 3, an LCD panel assembly according to the present embodiment includes signal lines including a plurality of gate lines GL, a plurality of pairs of data lines DLa and DLb, a plurality of storage electrode lines SL and a plurality of pixels PX connected to the signal lines.

Each pixel PX includes a pair of sub-pixels PXa and PXb, with each sub-pixel PXa/PXb including a switching element Qa/Qb that is respectively connected to the corresponding gate line GL and a data line DLa/DLb. Additionally, an LC capacitor Clca/Clcb is connected to the switching element Qa/ Qb, and a storage capacitor Csta/Cstb is connected to the switching element Qa/Qb and the storage electrode line SL.

Each switching element Qa/Qb may include, for example, a three-terminal element provided on the lower panel 100, having a control terminal connected to a gate line GL, an input terminal connected to a data line DLa/DLb, and an output terminal connected to both an LC capacitor Clca/Clcb and a storage capacitor Csta/Cstb.

The storage capacitor Csta/Cstb functions as an auxiliary capacitor for the LC capacitor Clca/Clcb and is formed by overlapping a storage electrode line SL provided on the lower panel 100 with a sub-pixel electrode PEa/PEb via an insulator disposed therebetween. The storage electrode line SL is supplied with a predetermined voltage, such as the common voltage Vcom. Alternatively, the storage capacitors Csta and Cstb may be formed by overlapping the sub-pixel electrodes PEa and PEb with a previous gate line thereabove via an insulator.

For purposes of simplicity, detailed descriptions of the LC capacitors Clca and Clcb, previously described above, will be omitted hereinbelow.

In an LCD including the above described LC panel assembly, the signal controller 600 may receive input image signals R, G, and B for a pixel PX and convert them into output image signals DAT (FIG. 1) for two sub-pixels PXa and PXb, which are transmitted to the data driver 500. On the other hand, separate sets of gray voltages for the two sub-pixels PXa and PXb may be generated by the gray voltage generator 800, with the sets of gray voltages being alternately applied to the data driver 500 or alternately selected by the data driver 500, thereby applying different voltages to the two sub-pixels PXa and PXb. However, it is desirable to compensate the image signals or generate sets of gray voltages such that the merged gamma curve of the two sub-pixels PXa and PXb is close to the frontal reference gamma curve. For example, the frontal merged gamma curve is made to accord with the frontal reference gamma curve that is determined to be the most appropriate for the LC panel assembly, and the lateral merged gamma curve is made to be most similar to the frontal reference gamma curve.

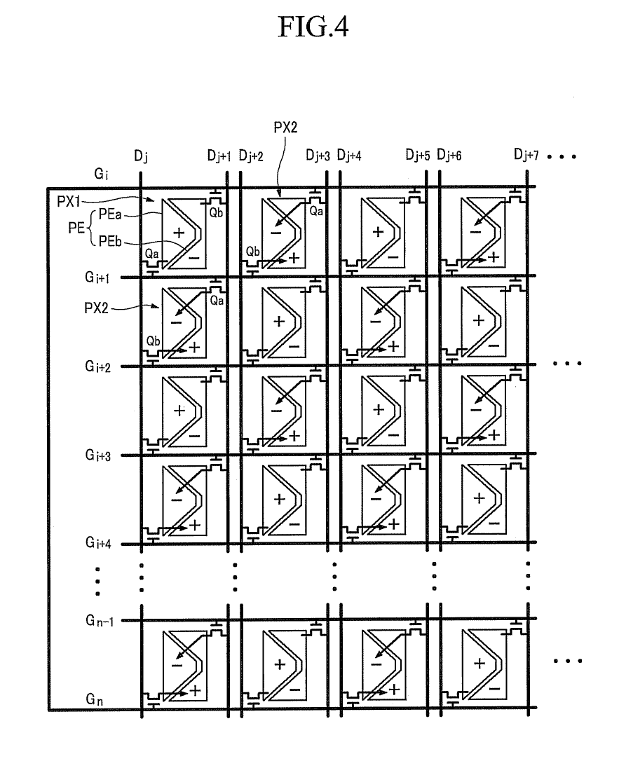

An exemplary schematic layout of such an LC panel assembly will now be described in detail with reference to FIG. 4.

FIG. 4 is a schematic diagram illustrating pixel disposition, signal line disposition, and pixel polarities of an LCD according to an exemplary embodiment of the present invention.

Referring to FIG. 4, an LC panel assembly according to an exemplary embodiment of the present invention includes pixel electrodes PE including a pair of sub-pixel electrodes PEa and PEb, a plurality of gate lines Gᵢ, Gᵢ₊₁, Gᵢ₊₂, Gᵢ₊₃, Gᵢ₊₄, . . . , Gₙ₋₁ and Gₙ extending in a horizontal direction, a plurality of data lines Dⱼ, Dⱼ₊₁, Dⱼ₊₂, Dⱼ₊₃, Dⱼ₊₄, Dⱼ₊₅, Dⱼ₊₆ and Dⱼ₊₇ . . . extending in a vertical direction, first switching elements Qa connected to the first sub-pixel electrodes PEa, and second switching elements Qb connected to the second sub-pixel electrodes PEb.

Polarities of the data voltages applied to two data lines (for example, Dⱼ and Dⱼ₊₁) connected to a pair of sub-pixels PEa and PEb forming a pixel electrode PE are opposite with respect to each other. For example, the polarity of a data voltage of the data line Dⱼ located on the left side of a given pixel electrode PE is positive (+), while the polarity of a data voltage of the data line Dⱼ₊₁ located on the right side of the pixel electrode PE is negative (−).

With regard to the specific pixel labeled PX1 disposed in the first row and the first column in FIG. 4, two gate lines (Gᵢ and Gᵢ₊₁) extend above and below PX1, while two data lines (Dⱼ and Dⱼ₊₁) extend along the left and right sides of PX1. The first switching element Qa connected to the first sub-pixel electrode PEa is connected to the lower gate line Gᵢ₊₁ and the left data line Dⱼ, while the second switching element Qb connected to the second sub-pixel electrode PEb is connected to the upper gate line Gᵢ and the right data line Dⱼ₊₁. Hereinafter, each pixel having this specific connection relationship will be generally referred to as a first pixel PX1.

With regard to one of the two the specific pixels labeled PX2 (i.e., the one disposed in the first row and the second column in FIG. 4), two gate lines (Gᵢ and Gᵢ₊₁) extend above and below PX2, while two data lines Dⱼ₊₂ and Dⱼ₊₃ extend along the left and right sides of PX2. The first switching element Qa connected to the first sub-pixel electrode PEa is connected to the upper gate line Gᵢ and the right data line Dⱼ₊₃, while the second switching element Qb connected to the second sub-pixel electrode PEb is connected to the lower gate line Gᵢ₊₁ and the left data line Dⱼ₊₂. Hereinafter, each pixel having this specific connection relationship will be generally referred to as a second pixel PX2.

Accordingly, the other pixel specifically labeled PX2 in FIG. 4, disposed in the second row and the first column has the same connection relationship as the pixel PX2 disposed in the first row and the second column. Stated another way, the first pixels PX1 and the second pixels PX2 are alternately disposed in the row direction and column direction.

As described above, the data lines Dⱼ, Dⱼ₊₁, Dⱼ₊₂, Dⱼ₊₃, Dⱼ₊₄, Dⱼ₊₅, Dⱼ₊₆, Dⱼ₊₇ . . . are disposed two by two on the left and right sides of the respective pixels PX. The gate lines Gᵢ, Gᵢ₊₁, Gᵢ₊₂, Gᵢ₊₃, Gᵢ₊₄, . . . Gₙ₋₁ and Gₙ are also disposed two by two above and below the respective pixels PX. However, the gate lines Gᵢ, Gᵢ₊₁, Gᵢ₊₂, Gᵢ₊₃, Gᵢ₊₄, . . . Gₙ₋₁ and Gₙ share a gate line Gᵢ₊₁, Gᵢ₊₂, Gᵢ₊₃, Gᵢ₊₄, . . . , Gₙ₋₁ between respective pixels PX. Therefore, the total number of the data lines Dⱼ, Dⱼ₊₁, Dⱼ₊₂, Dⱼ₊₃, Dⱼ₊₄, Dⱼ₊₅, Dⱼ₊₆, and Dⱼ₊₇ is twice the total number of the pixel columns, and the total number of the gate lines Gᵢ, Gᵢ₊₁, Gᵢ₊₂, Gᵢ₊₃, Gᵢ₊₄, . . . , Gₙ₋₁, and Gₙ is one more than the total number of pixel rows.

As further depicted in FIG. 4, the first gate line Gᵢ and the last gate line Gₙ are electrically connected with each other. Accordingly, the same gate driving circuit chip (not shown) is connected to the first gate line Gᵢ and the last gate line Gₙ, with the same gate signal being applied thereto. Therefore, all of gate lines Gᵢ, Gᵢ₊₁, Gᵢ₊₂, Gᵢ₊₃, Gᵢ₊₄, . . . Gₙ₋₁, and Gₙ may be driven without adding another gate driver.

As s result of the arrangement of the exemplary LC panel assembly 300 in FIG. 4, the polarities of the first and second sub-pixel electrodes PEa and PEb neighboring each other in a row direction are opposite to each other. Furthermore, the polarities of the first sub-pixel electrodes PEa neighboring each other in a column direction are opposite to each other, and the polarities of the second sub-pixel electrodes PEb neighboring each other in a column direction are also opposite to each other.

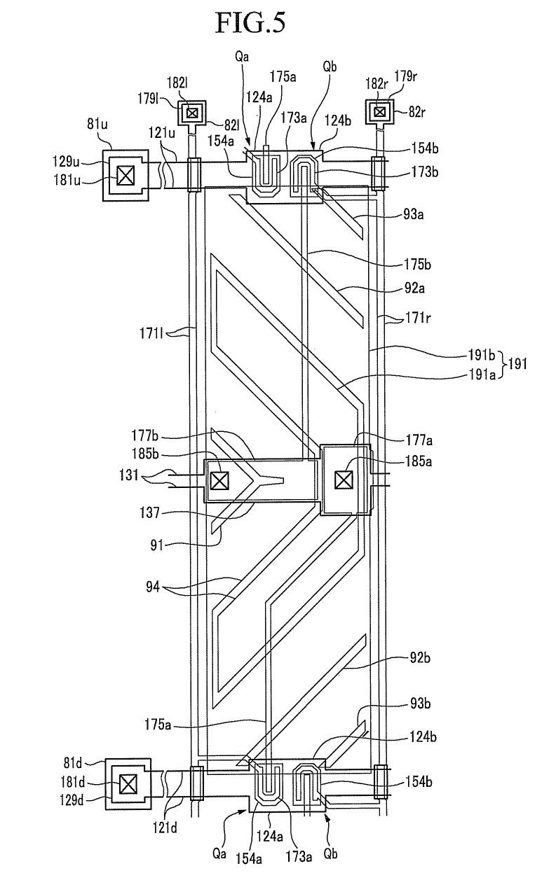

An LC panel assembly according to an exemplary embodiment of the present invention will now be described in detail with reference to FIG. 5 to FIG. 10.

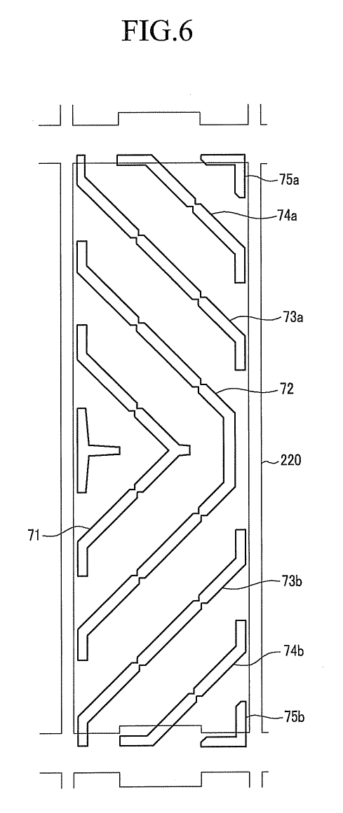

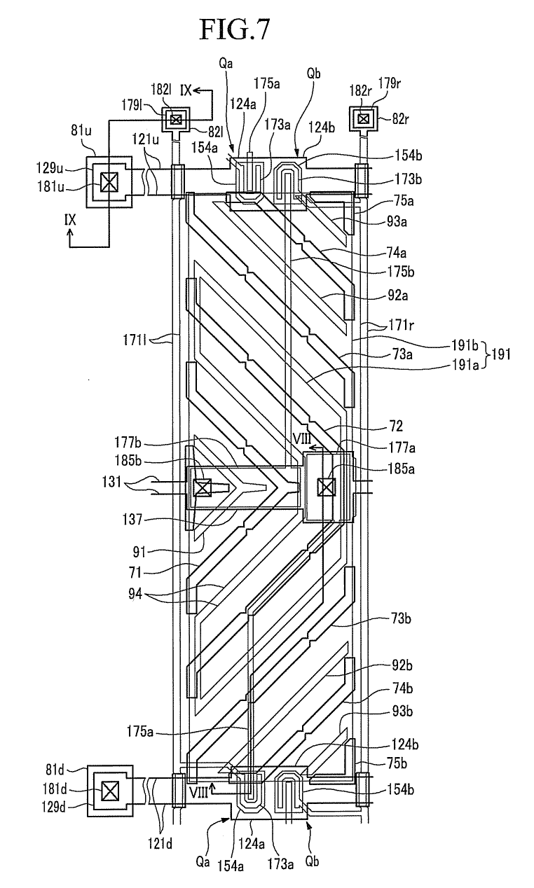

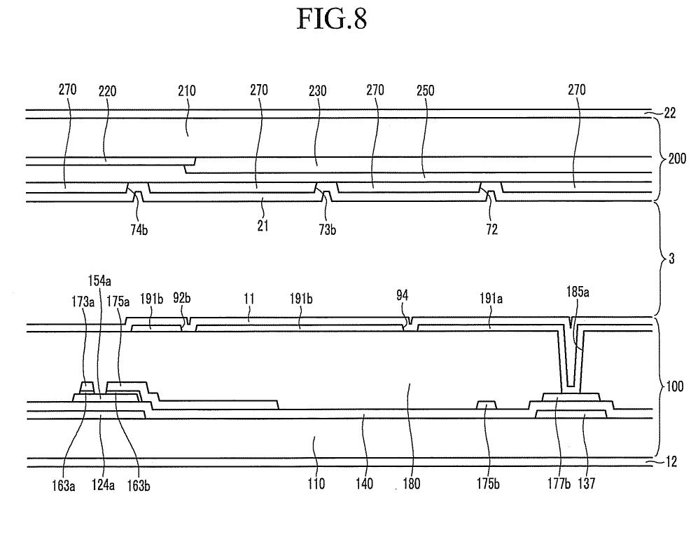

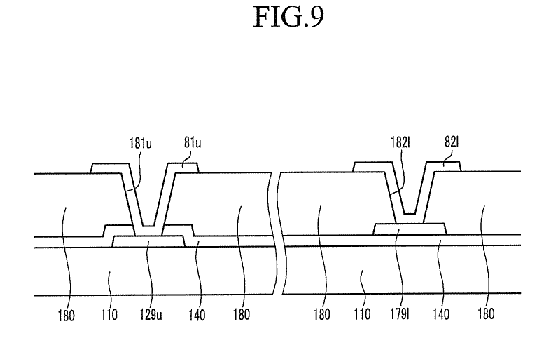

FIG. 5 is a layout view of a lower panel for a first pixel PX1 of an LC panel assembly according to an exemplary embodiment of the present invention, FIG. 6 is a layout view of an upper panel for a first pixel PX1 of an LC panel assembly according to an exemplary embodiment of the present invention. In addition, FIG. 7 is a layout view of an LC panel assembly including the lower panel shown in FIG. 5 and the upper panel shown in FIG. 6, while FIG. 8 and FIG. 9 are cross-sectional views of the first pixel PX1 shown in FIG. 7, respectively taken along the line VIII-VIII and the line IX-IX.

As indicated earlier with reference to FIG. 2, and as also seen in FIG. 8, an LCD according to an exemplary embodiment of the present invention includes a lower panel 100 and an upper panel 200 opposing the lower panel 100, and an LC layer 3 interposed between the two panels 100 and 200.

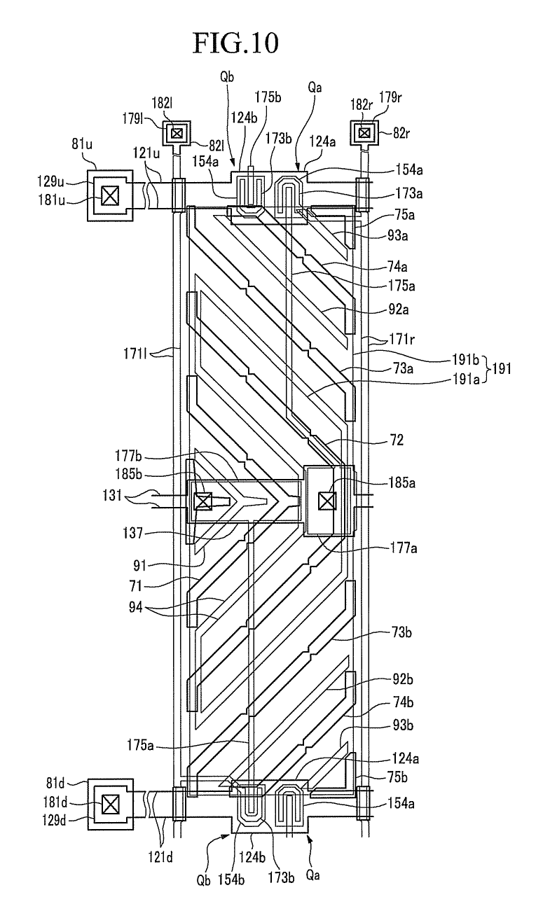

First, the lower panel 100 will be described in further detail with particular reference to FIG. 6, FIG. 8, FIG. 9, and FIG. 10.

A plurality of pairs of lower and upper gate lines 121d and 121u, and a plurality of storage electrode lines 131 are formed on an insulating substrate 110, which may be made of transparent glass, for example.

The lower and upper gate lines 121d and 121u are separated from each other, extending substantially in a transverse direction and are configured to transmit gate signals. Each of the lower and upper gate lines 121d and 121u includes a plurality of projections extending therefrom, forming for example a plurality of first and second gate electrodes 124a and 124b, as well as end portions 129d and 129u having a relatively large area for connection with another layer or an external driving circuit.

The storage electrode lines 131 also extend substantially in a transverse direction, and include a plurality of projections extending therefrom, forming for example storage electrodes 137. The storage electrode lines 131 are supplied with a predetermined voltage, such as a common voltage Vcom that is applied to the common electrode 270 of the LCD.

The gate lines 121d and 121u and the storage electrode lines 131 may be made, for example, of an aluminum (Al) containing metal such as Al or an Al alloy(s), a silver (Ag) containing metal such as Ag or a Ag alloy(s), a copper (Cu) containing metal such as Cu or a Cu alloy(s), a molybdenum (Mo) containing metal such as Mo or a Mo alloy(s), chromium (Cr), tantalum (Ta), and titanium (Ti). Alternatively, the gate lines 121d and 121u and the storage electrode lines 131 may have a multi-layered structure including two or more conductive layers (not shown) having different physical properties. At least of the two conductive layers may be made of a low resistivity metal such as an Al-containing metal, an Ag-containing metal, or a Cu-containing metal for reducing signal delay or voltage drop in the gate lines 121d and 121u and the storage electrode lines 131. On the other hand, at least one other conductive layer may be made of a material such as a Mo-containing metal, Cr, Ti, and Ta, which has good contact characteristics with other materials such as indium tin oxide (ITO) and indium zinc oxide (IZO). Specifically suitable examples of a combination of two layers include a first layer pair having a lower Cr layer and an upper Al (alloy) layer, and a second layer pair having a lower Al (alloy) layer and an upper Mo (alloy) layer. However, it will be appreciated the gate lines 121d and 121u and the storage electrode lines 131 may be made of many various metals or conductors in addition to the examples described above.

In addition, the lateral sides of the gate lines 121d and 121u and the storage electrode lines 131 are inclined relative to a surface of the substrate 110, with an exemplary inclination angle thereof ranging from about 30 degrees to about 80 degrees. A gate insulating layer 140, such as one made of silicon nitride (SiNx) is formed on the gate lines 121d and 121u and the storage electrode lines 131. A plurality of semiconductor islands 154a and 154b made of, for example, hydrogenated amorphous silicon ( “a-Si”) or polysilicon are formed on the gate insulating layer 140.

First ohmic contact islands 163a and second ohmic contact islands 163b made of, for example, silicide or n+ hydrogenated amorphous silicon (a-Si) and heavily doped with an n-type impurity such as phosphorus (P) are formed on the semiconductors 154a and 154b. The ohmic contact islands 163a and 163b are disposed in pairs on the semiconductors 154a and 154b, respectively.

The lateral sides of the semiconductors 154a and 154b and the ohmic contacts 163a are also inclined relative to a surface of the substrate 110, with an exemplary inclination angle thereof ranging from about 30 degrees to about 80 degrees.

A plurality of pairs of left and right data lines 171l and 171r and a plurality of pairs of first and second drain electrodes 175a and 175b are formed on the ohmic contacts 163a and the gate insulating layer 140. The data lines 171l and 171r extend substantially in a longitudinal direction, intersecting the gate lines 121d and 121u and the storage electrode lines 131, and are configured to transmit data voltages. The left and right data lines 171l and 171r include a plurality of first and second source electrodes 173a and 173b branched out toward the gate electrodes 124a and 124b, respectively, with each of the left and right data lines 171l and 171r including an end portion 179l and 179r having an extended area for connection with another layer or an external driving circuit.

The drain electrodes 175a and 175b are separated from the data lines 171l and 171r, with the drain electrodes 175a and 175b opposing the source electrodes 173a and 173b with respect to the gate electrodes 124a and 124b.

Each of the first and second drain electrodes 175a and 175b respectively include large area end portions 177a and 177b at a first end thereof, and narrow, stick-shaped end portions at a second end thereof. The large-area end portions 177a and 177b overlap the storage electrodes 137, while the stick-shaped end portions are partially surrounded by the source electrodes 173a and 173b, which are generally curved into a “U” shape.

The first/second gate electrodes 124a/124b, the first/second source electrodes 173a/173b, and the first/second drain electrodes 175a/175b, along with the semiconductor 154a/154b, form the first/second TFT Qa/Qb having a channel formed in the semiconductor 154a/154b disposed between the first/second source electrode 173a/173b and the first/second drain electrode 175a/175b.

The data lines 171l and 171r and the drain electrodes 175a and 175b may be made of a refractory metal such as, for example, Mo, Cr, Ta, and Ti, or an alloy(s) thereof. Also, the data lines 171 and the drain electrodes 175 may have a multi-layered structure including a refractory metal layer (not shown) and a conductive layer (not shown) having low resistivity. An example of such a multi-layered structure may include a double layer having a lower Cr or Mo (alloy) layer and an upper Al (alloy) layer, and a triple layer having a lower Mo (alloy) layer, an intermediate Al (alloy) layer, and an upper Mo (alloy) layer. However, the data lines 171l and 171r and the drain electrodes 175a and 175b may be made of many various metals or conductive materials, other than those described above.

The lateral sides of the data lines 171l and 171r and the drain electrodes 175a and 175b are also inclined relative to a surface of the substrate 110, similar to the gate lines 121d and 121u and the storage electrode lines 131, with exemplary inclination angles thereof ranging from about 30 degrees to about 80 degrees.

The ohmic contacts 163a are interposed only between the underlying semiconductors 154a and 154b and the overlying data lines 171l and 171r and the drain electrodes 175a and 175b thereon, and serve to reduce the contact resistance therebetween.

A passivation layer 180 is formed on the data lines 171l and 171r, the drain electrodes 175a and 175b, and the exposed portions of the semiconductors 154a and 154b. The passivation layer 180 may be made of an inorganic insulator such as, for example, silicon nitride or silicon oxide, an organic insulator, or a low dielectric insulator. The organic insulator and the low dielectric insulator have dielectric constants preferably lower than 4.0, with examples of the low dielectric insulators including a-Si:C:O and a-Si:O:F formed by plasma enhanced chemical vapor deposition (PECVD). The passivation layer 180 may be made of an organic insulator having photosensitivity, and the surface thereof may be flat. However, the passivation layer 180 may have a double-layered structure including a lower inorganic layer and an upper organic layer in order to not harm the exposed portions of the semiconductors 154a and 154b, as well as to make the most of the excellent insulating characteristics of an organic layer.

The passivation layer 180 has a plurality of contact holes 182l, 182r, 185a, and 185b respectively exposing the end portions 179l and 179r of the data lines 171l and 171r, and the passivation layer 180. The gate insulating layer 140 has a plurality of contact holes 181d and 181u respectively exposing the end portions 129d and 129u of the gate lines 121d and 121u.

A plurality of pixel electrodes 191, including first and second sub-pixel electrodes 191a and 191b, shielding electrodes (not shown), and a plurality of contact assistants 81d, 81u, 82l, and 82r are formed on the passivation layer 180. These elements may be made of a transparent conductor such as ITO or IZO, or a reflective metal such as Al, Ag, Cr, or alloys thereof.

The first/second sub-pixel electrode 191a/191b is physically and electrically connected to the first/second drain electrode 175a/175b through the contact hole 185a/185b and is supplied with a data voltage from the first/second drain electrode 175a/175b. A pair of sub-pixel electrodes 191a and 191b are applied with different data voltages that are preset for an input image signal, wherein the size of the data voltages may be set depending on the size and shape of the sub-pixel electrodes 191a and 191b. The areas of the sub-pixel electrodes 191a and 191b may be different from each other. As an example, the first sub-pixel electrode 191a is supplied with a higher voltage than the second sub-pixel electrode 191b, and the area of the first sub-pixel electrode 191a is smaller than that of the second sub-pixel electrode 191b.

The sub-pixel electrodes 191a and 191b that are supplied with data voltages generate electric fields in cooperation with the common electrode 270 so that the orientations of the LC molecules in the LC layer 3 interposed between the two electrodes 191a/191b and 270 are determined.

Also, as described above, each of the sub-pixel electrodes 191a and 191b and the common electrode 270 form an LC capacitor Clca and Clcb to store the applied voltages, even after the TFTs Qa are Qb is turned off. The first and second sub-pixel electrodes 191a and 191b and end portions 177a and 177b of the drain electrodes 175a and 175b connected to the first and second sub-pixel electrodes 191a and 191b overlap the storage electrode 137 to form storage capacitors Csta and Cstb, which are coupled in parallel with the LC capacitors Clca and Clcb to enhance the voltage storing capacity thereof.

Each pixel electrode 191 has four primary edges that are substantially parallel to the gate lines 121d and 121u or the data lines 171l and 171r, having a substantially quadrangle shape.

A pair of first and second sub-pixel electrodes 191a and 191b forming a pixel electrode 191 are disposed relative to each other with a gap 94 interposed therebetween, with the first sub-pixel electrode 191a being interposed in the center of the second sub-pixel electrode 191b.

A center cutout 91, upper cutouts 92a and 93a, and lower cutouts 92b and 93b are formed in the second sub-pixel electrode 191b, with the second sub-pixel electrode 191b thereby being divided into a plurality of regions (partitions) by the cutouts 91-93b. The cutouts 91-93b have a substantially inverted symmetry with respect to the storage electrode line 131.

The lower and the upper cutouts 92a-93b substantially extend in an oblique manner from a right edge of the pixel electrode 191 to the left and either to the upper edge or the lower edge of the pixel electrode 191. The lower and upper cutouts 92a-93b are disposed in the lower and upper halves with respect to the storage electrode line 131, respectively. The lower and upper cutouts 92a-93b form an angle of about 45 degrees with the gate lines 121d and 121u, thus extending substantially perpendicular to each other.

The center cutout 91 extends along the storage electrode line 131. The center cutout 91 is generally Y-shaped, having a central transverse portion and a pair of oblique portions. The central transverse portion extends approximately along the storage electrode line 131, and the pair of oblique portions extends approximately parallel with the lower and upper cutouts 92a-93b, respectively.

Therefore, the lower half of the pixel electrode 191 is partitioned into 5 partitions by the center cutout, the gap 94, and the lower cutouts 92b and 93b, and the upper half of the pixel electrode 191 is also partitioned into 5 partitions by the center cutout 91, the gap 94, and the upper cutouts 92a and 93a. In the embodiment illustrated, the number of regions or the number of cutouts may vary according to the size of a pixel, the ratio of the transverse and longitudinal edges of the pixel electrode, the type or characteristics of the LC layer 3, or other design factors.

The contact assistants 81d, 81u, 82l, and 82r are connected to end portions 129d and 129u of the gate lines 121d and 121u and the end portions 179l and 179r of the data lines 171l and 171r through the contact holes 181d, 181u, 182l and 182r, respectively. The contact assistants 81d, 81u, 82l, and 82r assist in the adhesion of the exposed end portions 179l, 179r, 129d, and 129u of the data lines 171l and 171r and the gate lines 121d and 121u to external apparatuses, as well as protecting those portions.

The upper panel 200 of the LC panel assembly 300 will now be described with reference to FIG. 6, FIG. 7 and FIG. 8.

A light blocking member 220 is formed on an insulating substrate 210, such as one formed from transparent glass or plastic, for example. The light blocking member 220 is also referred to as a black matrix, which prevents light leakage. The light blocking member 220 includes linear portions corresponding to the data lines 171l and 171r and planar portions corresponding to the TFTs, preventing light leakage between pixel electrodes 191 and defining openings that face the pixel electrodes 191. Alternatively, the light blocking member 220 may have a plurality of openings that face the pixel electrodes 191 and have substantially the same planar shape as the pixel electrodes 191.

A plurality of color filters 230 are also formed on the substrate 210. The color filters 230 are disposed substantially in the areas enclosed by the light blocking member 220, and they may extend in a longitudinal direction substantially along the pixel electrodes 191. Each color filter 230 may represent one of the primary colors such as red, green, and blue.

An overcoat 250 is formed on the color filters 230 and the light blocking member 200. The overcoat 250 is made of, for example, an (organic) insulator, which prevents the color filters 230 from being exposed and also provides a flat surface. Alternatively, the overcoat 250 may be omitted.

A common electrode 270 is formed on the overcoat 250. The common electrode 270 is made of a transparent conductive material such as, for example, ITO and IZO. The common electrode 270 has a plurality of sets of cutouts 71, 72, 73a, 73b, 74a, 74b, 75a, and 75b. A set of cutouts 71-75b face a pixel electrode 191 and includes first and second center cutouts 71 and 72, upper cutouts 73a, 74a, and 75a, and lower cutouts 73b, 74b, and 75b. Each of the cutouts 71-75b is disposed between adjacent cutouts 91-93b of the pixel electrode 191. Also, each of the cutouts 71-75b has at least an oblique branch extending parallel to the lower cutouts 92a and 93a or the upper cutouts 92b and 93b of the pixel electrode 191.

Each of the lower and upper cutouts 73a-75b includes an oblique branch, a transverse branch, and a longitudinal branch. The oblique branch extends approximately from a right edge of the pixel electrode 191 to the left and to the upper edge or the lower edge of the pixel electrode 191, and extends substantially parallel to the lower or the upper cutouts 92a-93b of the pixel electrode 191. The transverse branch and the longitudinal branch extend from respective ends of the oblique branch along the edges of the pixel electrode 191, overlapping the edges of the pixel electrode 191 and forming obtuse angles with the oblique branch.

Each of the first and second center cutouts 71 and 72 includes a central transverse branch, a pair of oblique branches, and a pair of terminal longitudinal branches. The central transverse branch extends approximately from a right edge of the pixel electrode 191 to the left along the transverse center line, and the pair of oblique branches extend from an end of the central transverse branch toward the left edge of the pixel electrode 191 substantially parallel to the lower and the upper cutouts 73a, 73b, 74a, 74b, 75a, and 75b, respectively. The terminal longitudinal branches extend from the respective ends of the oblique branches along the left edge of the pixel electrode 191, overlapping the left edge of the pixel electrode 191 and forming obtuse angles with the oblique branches.

Each of the oblique portions of the cutouts 71-75b include triangular notches formed therein. However, the notches may also be quadrangular, trapezoidal, or a semicircular in shape, as well as being convex or concave in shape. The notches determine the tilt directions of the LC molecules on the region boundaries corresponding to the cutouts 71-75b.

The number and/or direction of the cutouts 71-75b may also vary depending on design factors.

Alignment layers 11 and 21 are coated on inner surfaces of the panels 100 and 200, and may be homeotropic. Polarizers 12 and 22 are provided on outer surfaces of the panels 100 and 200, wherein the polarization axes may be perpendicular to each other, with one of the polarization axes substantially parallel to the gate lines 121d and 121u.

The LCD may include a backlight unit (not shown) for supplying light to the polarizers 12 and 22, the panels 100 and 200, and the LC layer 3. The LC layer 3 is in a state of negative dielectric anisotropy with the LC molecules in the LC layer 3 being aligned such that their longitudinal or major axes are substantially vertical to the surfaces of the panels 100 and 200, in the absence of an electric field. Therefore, incident light flowing into the LC layer 3 cannot pass through the crossed polarizers 12 and 22 and is blocked.

When a common voltage is applied to the common electrode 270 and data voltages are applied to the pixel electrodes 191, an electric field substantially perpendicular to the surfaces of the panels 100 and 200 is generated. The LC molecules tend to change their orientations in response to the electric field such that their longitudinal or major axes are perpendicular to the electric field direction. Both the pixel electrodes 191 and the common electrode 270 are commonly referred to as “field-generating electrodes.”

The cutouts 91-92b of the pixel electrode 191, the cutouts 71-75b of the common electrode 270 and the oblique edges of the pixel electrodes 191 that are parallel to those cutouts 91-93b and 71-74b distort the electric field so as to have a horizontal component that determines the tilt directions of the LC molecules. The horizontal component of the electric field is perpendicular to the oblique edges of the cutouts 91-93b and 71-75b and the oblique edges of the pixel electrodes 191.

A set of common electrode cutouts 71-75b and a set of pixel electrode cutouts 91-93b divide a pixel electrode 191 into a plurality of sub-areas, with each sub-area having two major edges that form oblique angles with the primary edges of the pixel electrode 191. Since the LC molecules on each sub-area tilt perpendicular to the major edges, the azimuthal distribution of the tilt directions are localized to four directions. In this manner, the reference viewing angle of the LCD is increased by making creating various tilt directions for the LC molecules.

At least one of the cutouts 91-93b and 71-75b may be substituted with protrusions or depressions, and the shapes and the arrangements of the cutouts 91-93b and 71-75b may be modified.

A second pixel PX2 of an LCD according to an exemplary embodiment of the present invention will now be described in detail with reference to FIG. 10.

FIG. 10 is a layout view of a second pixel PX2 of an LCD according to an exemplary embodiment of the present invention.

Referring to FIG. 10, a second pixel PX2 of an LCD according to an exemplary embodiment of the present invention also includes a lower panel (not shown in FIG. 10) and an upper panel (not shown in FIG. 10) facing each other, and an LC layer (not shown in FIG. 10) interposed therebetween.

The layered structure of the LC panel assembly according to the present exemplary embodiment is substantially the same as the layered structure of the LC panel assembly illustrated in FIG. 5 to FIG. 9.

With regard to the lower panel, a plurality of gate conductors including a plurality of upper and lower gate lines 121u and 121d and a plurality of storage electrode lines 131 are formed on an insulating substrate (not shown in FIG. 10). Each of the gate lines 121u and 121d includes gate electrodes 124a and 124b and an end portion 129u and 129d, and each of the storage electrode lines 131 includes storage electrodes 137. A gate insulating layer (not shown) is formed on the gate conductors 121u, 121d, and 131. First and second semiconductor islands 154a and 154b are formed on the gate insulating layer and a plurality of ohmic contacts (not shown in FIG. 10) are formed thereon. Data conductors including a plurality of right and left data lines 171r and 171l and a plurality of first and second drain electrodes 175a and 175b are formed on the ohmic contacts and the gate insulating layer. The right and left data lines 171r and 171l include a plurality of first and second source electrodes 173a and 173b and end portions 179r and 179l. A passivation layer (not shown in FIG. 10) is formed on the data conductors 171r, 171l, 175a, 175b, 177a, and 177b and the exposed portions of the semiconductors 154a and 154b, and the passivation layer and the gate insulating layer have a plurality of contact holes 181, 182a, 182b, 185a, and 185b. A plurality of first and second sub-pixel electrodes 191a and 191b and a plurality of contact assistants 81u, 81d, 82r, and 821 are formed on the passivation layer. An alignment layer (not shown in FIG. 10) is formed on the pixel electrodes 191, the contact assistants 81u, 81d, 82r, and 82l, and the passivation layer.

Regarding the upper panel, a light blocking member (not shown in FIG. 10), a plurality of color filters (not shown in FIG. 10), an overcoat (not shown in FIG. 10), a common electrode (not shown in FIG. 10), and an alignment layer (not shown in FIG. 10) are formed on an insulating substrate (not shown in FIG. 10).

In the second pixel PX2 shown in FIG. 10, an in contrast to the first pixel PX1 shown in FIG. 5 to FIG. 9, the first TFT Qa including the first semiconductor 154a, the first source electrode 173a, and the first drain electrode 175a is disposed above the pixel electrode 191, and the second TFT Qb including the second semiconductor 154b, the second source electrode 173b, and the second drain electrode 175b is disposed below the pixel electrode 191.

Also, each of the first and second drain electrodes 175a and 175b shown in FIG. 10 also includes respective end portions 177a and 177b having a large area. The first and second drain electrodes 175a and 175b are physically and electrically connected with the end portions 177a and 177b, respectively. The drain electrodes 175a and 175b are maintained in a floating state during a manufacturing process, thereby preventing occurrence of adverse static electricity effects.

The operation of the above described liquid crystal display will now be described in detail.

Referring once again to FIG. 1, the signal controller 600 is supplied with input image signals R, G, and B, and input control signals including a vertical synchronization signal Vsync, a horizontal synchronization signal Hsync, a main clock signal MCLK, and a data enable signal DE, for controlling the display of the input image signals R, G, and B from an external graphics controller (not shown). On the basis of the input control signals and the input image signals R, G, and B, the signal controller 600 appropriately processes the input image signals R, G, and B to be suitable for the operating conditions of the LC panel assembly 300 and generates gate control signals CONT1 and data control signals CONT2. The signal controller 600 then transmits the gate control signals CONT1 to the gate driver 400 and transmits the processed image signals DAT and the data control signals CONT2 to the data driver 500.

The gate control signals CONT1 include a scanning start signal STV (not shown) for initiating the scanning of a gate-on voltage Von, a gate clock signal CPV (not shown) for controlling the output time of the gate-on voltage Von, and an output enable signal OE (not shown) for defining the duration width of the gate-on voltage Von.

The data control signals CONT2 include a horizontal synchronization start signal STH (not shown) for synchronizing the start of data transmission for a row of sub-pixels PXa and PXb (FIG. 3), a load signal LOAD (not shown) for initiating the application of corresponding data voltages to the data lines D₁-D₂ₘ, and a data clock signal HCLK (not shown). The data control signal CONT2 may further include an inversion signal RVS (not shown) for reversing the polarity of the data voltages with respect to the common voltage Vcom.

Responsive to the data control signals CONT2 from the signal controller 600, the data driver 500 sequentially receives and shifts image data DAT for a row of sub-pixels PXa and PXb, selects gray voltages corresponding to the respective image data DAT among gray voltages from the gray voltage generator 800, converts the image data DAT into corresponding analog data voltages, and applies the analog data voltages to the corresponding data lines D₁-D₂ₘ.

The gate driver 400 applies the gate-on voltage Von to the gate lines G₁-Gₙ in response to the gate control signals CONT1 from the signal controller 600, thereby turning on the switching elements Qa and Qb connected to the gate lines G₁-Gₙ, and accordingly, data voltages applied to data lines D₁-D₂ₘ are applied to the corresponding sub-pixels PXa and PXb through the turned-on switching elements Qa and Qb.

The differences between the data voltages applied to the sub-pixels PXa and PXb and the common voltage Vcom appear as charge voltages of each of the LC capacitors Clca and Clcb, i.e., the sub-pixel voltages. The arrangement of LC molecules varies depending on the intensity of the sub-pixel voltages, and thus the polarization of light passing through the LC layer 3 varies. As a result, the transmittance of the light is varied by the polarizers 12 and 22 attached to the panels 100 and 200.

An input image data is converted into a pair of output image data, which gives different transmittances to a pair of sub-pixels PXa and PXb from each other. Consequently, the two sub-pixels PXa and PXb represent different gamma curves, wherein the gamma curve of one pixel PX is a synthesized curve of the gamma curves. The synthesized gamma curve for the front view is determined to be equal to the reference gamma curve for the front view that is most suitable, and the synthesized gamma curve for the lateral view is determined to be closest to the reference gamma curve for the front view. In this manner, lateral visibility is improved by converting the image data. Also, as described above, the area of the first sub-pixel electrode 191a supplied with a relatively high voltage is smaller than the area of the second sub-pixel electrode 191b, thereby decreasing a distortion of the synthesized gamma curve for the lateral view.

After 1 horizontal period (which is also referred to as “1H” which is one period of the horizontal synchronization signal Hsync and the data enable signal DE), the data driver 500 and the gate driver 400 repeat the same procedure for the next row of sub-pixels PXa and PXb. In this manner, all gate lines G₁-Gₙ are sequentially supplied with the gate-on voltage Von during a frame, thereby applying data voltages to all sub-pixels PXa and PXb. When the next frame starts after one frame is finished, the inversion signal RVS applied to the data driver 500 is controlled such that the polarity of the data voltage applied to each of the sub-pixels PXa and PXb is reversed so as to be opposite to the polarity in the previous frame (which is referred to as “frame inversion”).

In addition to frame inversion, the data driver 500 reverses the polarity of the data voltages flowing in neighboring data lines D₁-D₂ₘ during one frame, and accordingly, the polarity of voltage of the sub-pixel applied with the data voltage also varies. Depending on the connection relationship between the data driver 500 and the data lines D₁-D₂ₘ, the polarity inversion pattern generated by the data driver 500 is different from the polarity inversion pattern of sub-pixel voltages appearing on the screen of the LC panel assembly 300. The polarity inversion of the data driver 500 is also referred to as “driver inversion,” and the polarity inversion appearing on the screen is also referred to as “apparent inversion.”

Also, for convenience of description, “the polarity of the sub-pixel voltage in the sub-pixel PXa and PXb” is abbreviated to a “polarity of the sub-pixel PXa and PXb”, and “the polarity of the pixel voltage in the pixel PX” is abbreviated to a “polarity of the pixel PX.”

Since apparent inversion types of LCDs according to various exemplary embodiments of the present invention have been described above with the polarities of the first and the second sub-pixel electrodes PEa and PEb of FIG. 4, additional description is omitted.

According to the present invention embodiments, degradation of image quality in a high-speed, column inversion driving method may be prevented, and drain electrodes are maintained in a floating state during a process such that occurrence of static electricity inferiority may be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a plurality of pixels arranged in a matrix and grouped into one of first and second pixels;
a plurality of gate lines including a plurality of pairs of first and second gate lines opposing each other with respect to the plurality of pixels; and
a plurality of data lines including a plurality of pairs of first and second data lines intersecting the gate lines;
wherein each of the first and the second pixels further comprises:
a plurality of pixel electrodes, each of the pixel electrodes including first and second sub-pixel electrodes;
a first switching element disposed on a right side of the first data line;
a second switching element disposed on a left side of the second data line;
wherein the first switching element is connected to the first sub-pixel electrode and wherein the second switching element is connected to the second sub-pixel electrode in the first pixel; and
the first switching element is connected to the second sub-pixel electrode with the second switching element connected to the first sub-pixel electrode in the second pixel.

2. The liquid crystal display of claim 1, wherein a total number of the data lines is twice a total number of columns of the pixels, and a total number of the gate lines is one more than a total number of rows of the pixels.

3. The liquid crystal display of claim 1, wherein data voltages applied to the first and second sub-pixel electrodes are different from each other and are obtained from single image information.

4. The liquid crystal display of claim 1, wherein the first pixels and the second pixels are alternately disposed in a row direction.

5. The liquid crystal display of claim 1, wherein the first pixels and the second pixels are alternately disposed in a column direction.

6. The liquid crystal display of claim 1, wherein polarities of data voltages applied to neighboring data lines are opposite to each other.

7. The liquid crystal display of claim 1, wherein a polarity of a voltage of the first sub-pixel electrode is opposite to a polarity of a voltage of the second sub-pixel electrode.

8. The liquid crystal display of claim 7, wherein polarities of voltages of the first sub-pixel electrodes neighboring each other in a row and a column direction are opposite to each other.

9. The liquid crystal display of claim 7, wherein polarities of voltages of the second sub-pixel electrodes neighboring each other in a row and a column direction are opposite to each other.

10. The liquid crystal display of claim 3, wherein an area of the first sub-pixel electrode is smaller than an area of the second sub-pixel electrode.

11. The liquid crystal display of claim 10, wherein a voltage of the first sub-pixel electrode is higher than a voltage of the second sub-pixel electrode.

12. The liquid crystal display of claim 1, wherein a first cutout is formed in at least one of the first and second sub-pixel electrodes.

13. The liquid crystal display of claim 12, further comprising a common electrode opposing the pixel electrode; wherein a second cutout is formed in the common electrode.

14. The liquid crystal display of claim 2, wherein the first gate line is connected with the last gate line.

15. The liquid crystal display of claim 1, further comprising a storage electrode overlapping the first and second sub-pixel electrodes;
wherein the first switching element comprises a first gate electrode, a first source electrode, and a first drain electrode, and the second switching element comprises a second gate electrode, a second source electrode, and a second drain electrode; and
the first drain electrode and the second drain electrode include first and second expansions overlapping the storage electrode, respectively, and the first drain electrode is physically connected to the first expansion while the second drain electrode is physically connected to the second expansion.

16. The liquid crystal display of claim 1, wherein each pixel electrode has a substantially quadrangle shape.

17. The liquid crystal display of claim 1, wherein the first and second sub-pixel electrodes are disposed relative to each other with a gap interposed therebetween, with the first sub-pixel electrode being interposed in the center of the second sub-pixel electrode.

18. The liquid crystal display of claim 17, further comprising:
a center cutout, a pair of upper cutouts, and a pair of lower cutouts formed in the second sub-pixel electrode, the second sub-pixel electrode thereby being divided into a plurality of regions by the cutouts; and
a storage electrode overlapping the first and second sub-pixel electrodes;
wherein the cutouts have a substantially inverted symmetry with respect to the storage electrode.

19. The liquid crystal display of claim 18, wherein the pairs of lower and upper cutouts extend in a substantially oblique manner from a right edge of the pixel electrode to the left and to one of an upper edge and a lower edge of the pixel electrode.

20. The liquid crystal display of claim 19, wherein the pairs of lower and upper cutouts extend substantially perpendicular to each other.

21. The liquid crystal display of claim 18, wherein the center cutout is generally Y-shaped, having a central transverse portion and a pair of oblique portions, with the central transverse portion extending approximately along the storage electrode, and the pair of oblique portions extending approximately parallel with the pairs of lower and upper cutouts, respectively.

22. The liquid crystal display of claim 1, further comprising:
a common electrode opposing the pixel electrode;
the common electrode further comprising a set of cutouts, including first and second center cutouts, a plurality of upper cutouts, and plurality of lower cutouts.

23. The liquid crystal display of claim 22, wherein each of the plurality of lower and upper cutouts includes an oblique branch, a transverse branch, and a longitudinal branch;
the oblique branch extending approximately from a right edge of the pixel electrode to the left and to one of the upper edge and the lower edge of the pixel electrode;
the transverse branch and the longitudinal branch extending from respective ends of the oblique branch along the edges of the pixel electrode, overlapping the edges of the pixel electrode and forming obtuse angles with the oblique branch.

24. The liquid crystal display of claim 22, wherein each of the first and second center cutouts includes a central transverse branch, a pair of oblique branches, and a pair of terminal longitudinal branches;
the central transverse branch extends approximately from a right edge of the pixel electrode to the left along a transverse center line, and the pair of oblique branches extending from an end of the central transverse branch toward the left edge of the pixel electrode; and
the terminal longitudinal branches extending from the respective ends of the oblique branches along the left edge of the pixel electrode, overlapping the left edge of the pixel electrode and forming obtuse angles with the oblique branches.

25. The liquid crystal display of claim 23, wherein each of the oblique branches of the lower and upper cutouts includes notches formed therein.

26. The liquid crystal display of claim 24, wherein each of the oblique branches of the first and second center cutouts includes notches formed therein.
